(19) United States
(12) Patent Application Publication
(10) Pub. No.: US 2026/0234000 A1
(43) Pub. Date: Aug. 13, 2026

(54) ELECTRODE MATERIAL FOR HYBRID SODIUM ION CAPACITOR INCLUDING THREE-DIMENSIONAL POROUS CARBON COMPOSITE DOPED WITH HETEROGENEOUS ELEMENTS

(71) Applicant: KOREA ADVANCED INSTITUTE OF SCIENCE AND TECHNOLOGY, Daejeon (KR)

(72) Inventors: Jeung Ku KANG, Daejeon (KR); Do Hwan JUNG, Daejeon (KR); Keon Han KIM, Daejeon (KR); Jong Hui CHOI, Daejeon (KR); Dong Won KIM, Daejeon (KR)

(21) Appl. No.: 19/247,397

(22) Filed: Jun. 24, 2025

(30) Foreign Application Priority Data
Feb. 13, 2025 (KR) 10-2025-0018452

(51) Int. Cl. C01B 32/05; C01B 32/198; H01G 11/24; H01G 11/32

(52) U.S. Cl. CPC C01B 32/05; C01B 32/198; H01G 11/24; H01G 11/32; C01B 2204/22; C01P 2002/52; C01P 2004/02; C01P 2006/40

(57) ABSTRACT

An embodiment relates to an electrode material for a hybrid sodium ion capacitor including a three-dimensional porous carbon composite doped with heterogeneous elements. A hybrid sodium ion capacitor including a porous carbon composite doped with heterogeneous elements as an electrode substance according to one embodiment can achieve a high energy density of 247 Wh/kg, which exceeds the general energy density of 150 Wh/kg of a conventional lithium ion battery, and further has an effect of exhibiting an energy density of 150 Wh/kg or more even when charged for only 1 minute.

### CROSS REFERENCE TO RELATED APPLICATION

The present application claims priority to Korean Patent Application No. 10-2025-0018452, filed Feb. 13, 2025, the entire contents of which are incorporated here for all purposes by this reference.

### BACKGROUND

The disclosure relates to an electrode material for a sodium ion hybrid capacitor which exhibits both high energy density and high power density, and more particularly, to synthesizing a porous carbon composite doped with heterogeneous elements derived from a metal-organic framework (MOF), and to a negative electrode material and a positive electrode material produced based thereon.

Capacitors are important energy storage apparatuses that store and supply a large amount of electrical energy together with batteries. In particular, a capacitor with a very large storage capacity is called a super capacitor.

In addition, a hybrid capacitor is an energy storage apparatus that combines the advantages of a battery and a super capacitor, and provides a high energy density like a battery while also providing a fast charge/discharge speed like a super capacitor.

Accordingly, since a super capacitor must have high energy storage capacity and performance as an electrode substance, an electrode substance such as activated carbon with a large surface area must be used.

Meanwhile, a metal-organic framework (MOF) is a composition made of metal ions and organic linkers. These MOFs may control the porosity characteristics depending on the type of metal ion and organic linker used, and through heat treatment, porous carbon bodies and metal oxides with very high surface areas may be produced.

Furthermore, MOFs may be applied to various existing substances, so they may be made into various energy storage substances, and by adding organic linkers or other substances used in MOFs, nitrogen (N), sulfur (S), phosphorus (P), etc. may be doped to synthesize compositions with improved electrical properties. Due to these advantages, many types of MOF matters have recently been applied to energy storage systems (ESS).

In addition, since sodium (Na) exists on Earth in more than 500 times the amount of lithium (Li) used in conventional technologies, sodium ion hybrid capacitors utilizing this are attracting attention as next-generation energy storage apparatuses.

At this time, conventional sodium ion capacitors have fundamental limitations such as low output, limited storage characteristics, and long charging time compared to lithium ion capacitors, and in order to implement a high-performance hybrid capacitor, there is a problem that the relatively slow energy storage speed of the negative electrode must be improved and the energy storage capacity of the positive electrode material, which has a relatively low capacity compared to the negative electrode, must be increased.

Therefore, there are still many challenges remaining in producing a negative electrode with improved energy storage speed and a positive electrode with improved energy storage capacity.

### Related Art Document

### [Patent Document]

Republic of Korea Patent No. 10-1438065

### SUMMARY

An aspect of the disclosure is to synthesize a porous carbon composite doped with heterogeneous elements derived from a metal-organic framework (MOF), and to provide a negative electrode material for a battery containing an active matter having a fine particle size of several nanometers based on the porous carbon composite.

The aspect of the disclosure is not limited to that mentioned above, and other aspects not mentioned will be clearly understood by those skilled in the art from the description below.

An embodiment of the disclosure provides a three-dimensional porous carbon composite.

The three-dimensional porous carbon composite according to an embodiment of the disclosure, which is a three-dimensional porous carbon framework derived from a metal-organic framework (MOF), may include: a graphitized carbon structure produced through a heat treatment and subsequent treatment process of the metal-organic framework (MOF), and having a three-dimensional network structure; and heterogeneous elements dispersed and doped inside the graphitized carbon structure, and composed of nitrogen (N), sulfur (S), or oxygen (O), wherein the three-dimensional porous carbon composite is used as a material for a negative electrode or a positive electrode of a hybrid sodium ion capacitor.

In addition, according to an embodiment of the disclosure, in the graphitized carbon structure, when used as a negative electrode of a hybrid sodium ion capacitor, the metal-organic framework (MOF) may include MIL-100(Fe) and graphene oxide, and when used as a positive electrode of a hybrid sodium ion capacitor, the metal-organic framework (MOF) may include ZIF-8.

In addition, according to an embodiment of the disclosure, in the graphitized carbon structure, with respect to the subsequent treatment process, when used as a negative electrode of a hybrid sodium ion capacitor, a metal-organic framework (MOF) support may be converted through a sulfidation process, and when used as a positive electrode of a hybrid sodium ion capacitor, the metal-organic framework (MOF) support may be converted through a KOH activation process.

In addition, according to an embodiment of the disclosure, when the three-dimensional porous carbon composite is used as a negative electrode material, low-crystallinity multivalent iron sulfide (Fe²⁺ or Fe³⁺) may be inserted into the graphitized carbon structure, and a sulfur (S)-doped and nitrogen (N)-doped structure may be formed.

In addition, according to an embodiment of the disclosure, the low-crystallinity polyvalent iron sulfide may include 70 wt. % or more and 71 wt. % or less of the total negative electrode material.

In addition, according to an embodiment of the disclosure, the low-crystalline polyvalent iron sulfide may have an average particle size of 3 nm to 5 nm.

In addition, according to an embodiment of the disclosure, the nitrogen (N) may be doped at 2 to 3 atomic % of the total negative electrode material.

In addition, according to an embodiment of the disclosure, when the three-dimensional porous carbon composite is used as a positive electrode material, a structure in which oxygen (O) and nitrogen (N) are doped in the graphitized carbon structure may be formed.

In addition, according to an embodiment of the disclosure, the oxygen (O) may be doped at 6 to 7 atomic % of the total positive electrode material, and nitrogen (N) is doped at 2 to 3 atomic % of the total positive electrode material.

In addition, according to an embodiment of the disclosure, when the three-dimensional porous carbon composite is used as a positive electrode material, a micropore ratio of 10% or more may be ensured.

In addition, according to an embodiment of the disclosure, the three-dimensional porous carbon composite promotes the adsorption of negative ions (ClO⁴⁻) by micropores of the positive electrode material.

A hybrid sodium ion capacitor including a porous carbon composite doped with heterogeneous elements as an electrode substance according to one embodiment of the disclosure can achieve a high energy density of 247 Wh/kg, which exceeds the general energy density of 150 Wh/kg of a conventional lithium ion battery, and further has an effect of exhibiting an energy density of 150 Wh/kg or more even when charged for only 1 minute.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A, 1B, and 1C are each a schematic diagram showing a method for producing a three-dimensional porous carbon composite of the disclosure and a view showing an application example to a hybrid sodium ion capacitor;

FIGS. 2A, 2B, 2C, 2D, 2E, 2F, 2G, 2H, and 2I are each an optical image showing the structural characteristics of a three-dimensional porous carbon composite negative electrode material of the disclosure;

FIGS. 3A, 3B, 3C, 3D, 3E, 3F, 3G, and 3H are each a graph showing the electrochemical performance and characterization of a three-dimensional porous carbon composite negative electrode material of the disclosure;

FIGS. 4A, 4B, 4C, 4D, 4E, and 4F are each an optical image showing the structural characteristics of a three-dimensional porous carbon composite positive electrode material of the disclosure;

FIGS. 5A, 5B, 5C, and 5D are each a graph showing the electrochemical performance and characterization of a three-dimensional porous carbon composite positive electrode material of the disclosure; and

FIGS. 6A, 6B, 6C, 6D, 6E, and 6F are each a graph showing electrochemical characterizations of a hybrid sodium ion capacitor including a three-dimensional porous carbon composite negative electrode material and positive electrode material of the disclosure.

### DETAILED DESCRIPTION

Hereinafter, the disclosure will be described with reference to the accompanying drawings. However, the disclosure may be implemented in various different forms and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a certain component, this does not exclude other components unless specifically stated to the contrary, but rather means that other components may be additionally provided.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings. For reference, the drawings may be expressed in some exaggerated manner to explain the features of the disclosure. In this case, it is preferable to interpret them in light of the entire intent of the present specification.

### A Three-dimensional Porous Carbon Composite According to an Embodiment of the Disclosure Will be Described

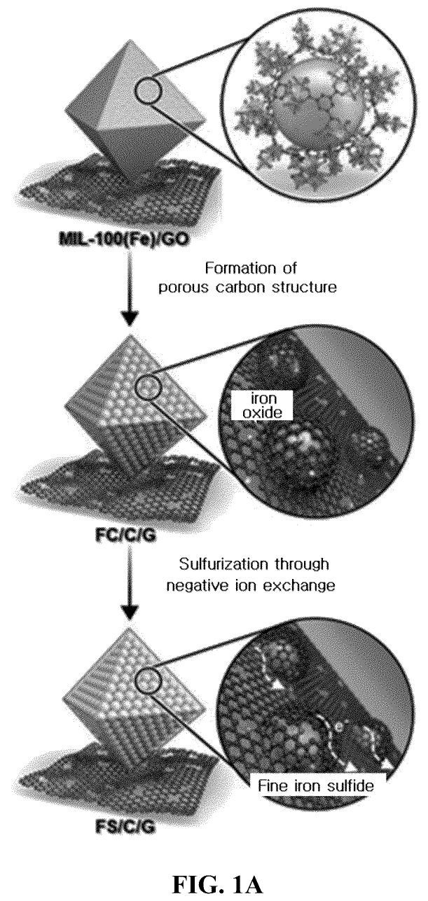

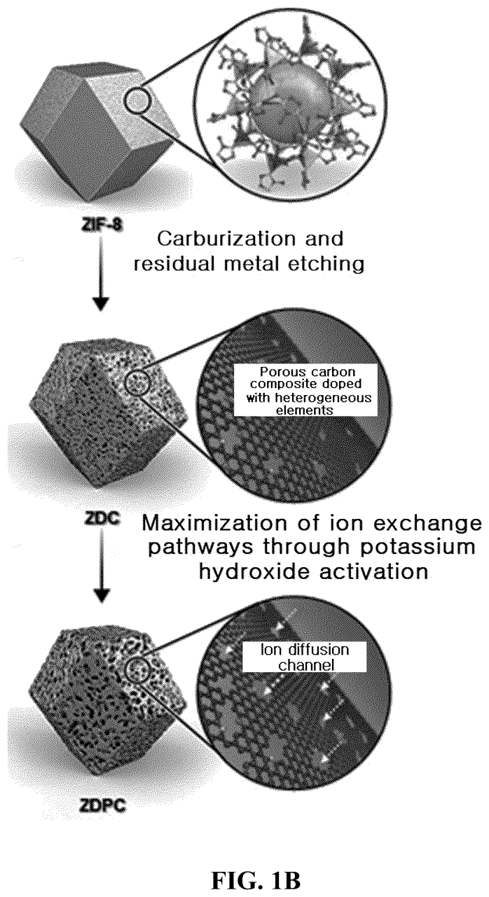

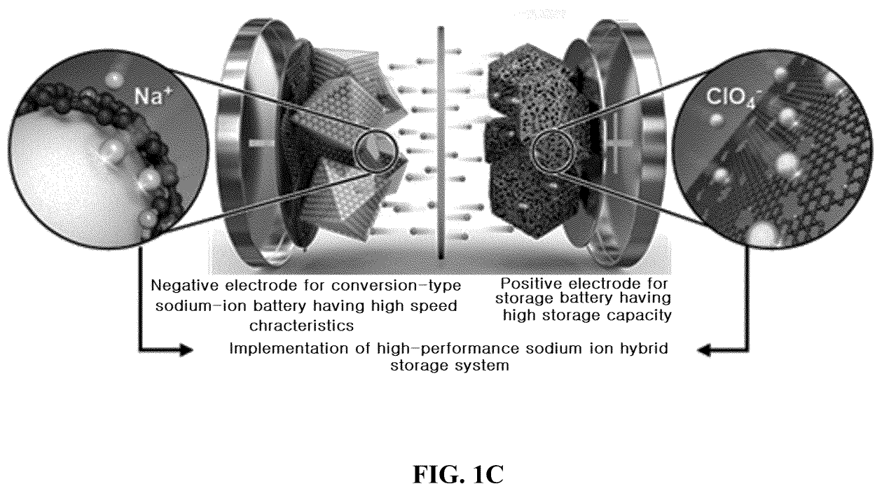

FIGS. 1A, 1B, and 1C are each a schematic diagram showing a method for producing a three-dimensional porous carbon composite of the disclosure and a view showing an application example to a hybrid sodium ion capacitor.

Referring to FIGS. 1A, 1B, and 1C, a three-dimensional porous carbon composite according to an embodiment of the disclosure, which is a three-dimensional porous carbon framework derived from a metal-organic framework (MOF), may include: a graphitized carbon structure produced through a heat treatment and subsequent treatment process of the metal-organic framework (MOF), and having a three-dimensional network structure; and heterogeneous elements dispersed and doped inside the graphitized carbon structure, and composed of nitrogen (N), sulfur (S), or oxygen (O), wherein the three-dimensional porous carbon composite is used as a material for a negative electrode or a positive electrode of a hybrid sodium ion capacitor.

The three-dimensional porous carbon composite of the disclosure is characterized by providing a porous carbon composite doped with heterogeneous elements derived from a metal-organic framework (MOF), wherein the three-dimensional porous carbon composite of the disclosure may be used as a material of a negative electrode or a positive electrode of a hybrid sodium ion capacitor, and the negative electrode material and the positive electrode material may be different matters.

In addition, the disclosure may include a graphitized carbon structure, wherein when used as a negative electrode of the hybrid sodium ion capacitor, the metal-organic framework (MOF) may include MIL-100(Fe) and graphene oxide, and, when used as a positive electrode of the hybrid sodium ion capacitor, the metal-organic framework (MOF) may include ZIF-8.

At this time, the graphitized carbon structure of the disclosure is converted through a heat treatment and subsequent treatment process of the metal-organic framework (MOF), and may have a three-dimensional network structure.

At this time, the metal-organic framework (MOF) may be carbonized and graphitized through heat treatment.

In addition, with respect to the subsequent treatment process, when used as a negative electrode of a hybrid sodium ion capacitor, the metal-organic framework (MOF) support may be converted through a sulfidation process, and when used as a positive electrode of a hybrid sodium ion capacitor, the metal-organic framework (MOF) support may be converted through a KOH activation process. At this time, the subsequent treatment process described above will be described in detail in a production example below.

At this time, when the three-dimensional porous carbon composite is used as a negative electrode material, formed is a structure in which low-crystalline polyvalent iron sulfide (Fe²⁺ or Fe³⁺) is inserted into the graphitized carbon structure, and is sulfur (S)-doped and nitrogen (N)-doped.

At this time, the low-crystallinity multi-ferrous sulfide may be included in an amount of 70 wt. % or more and 71 wt. % or less of the entire negative electrode material.

If the low-crystallinity multi-ferrous sulfide is included in an amount of less than 70 wt. % of the entire negative electrode material, there may be a problem that the sodium ion storage capacity is reduced, and if this is included in an amount of more than 71 wt. %, there may be a problem that the life of the battery is reduced.

In addition, the low-crystallinity multi-ferrous sulfide may have an average particle size of 3 nm to 5 nm.

At this time, the nitrogen (N) doped into the graphitized carbon structure is doped in an amount of 2 atomic % to 3 atomic % of the entire negative electrode material.

At this time, if the doping content of the sulfur doped into the graphitized carbon structure decreases, the electrical conductivity of the electrode matter may decrease.

In addition, if the doped nitrogen in the graphitized carbon structure is less than 2 atomic % of the entire negative electrode material, there may be a problem of reduced electrical conductivity and storage capacity.

In addition, if the three-dimensional porous carbon composite is used as a positive electrode material, the graphitized carbon structure may be formed as a structure in which oxygen (O) and nitrogen (N) are doped.

At this time, the oxygen (O) may be doped in an amount of 6 to 7 atomic % of the entire positive electrode material, and the nitrogen (N) may be doped in an amount of 2 to 3 atomic % of the entire positive electrode material.

At this time, if the doped oxygen (O) in the graphitized carbon structure is less than 6 atomic % of the entire positive electrode material, there may be a problem of reduced electrical conductivity and storage capacity.

In addition, if the doped nitrogen (N) in the graphitized carbon structure is less than 2 atomic % of the entire positive electrode material, there may be a problem of reduced electrical conductivity and storage capacity.

At this time, when the three-dimensional porous carbon composite is used as a positive electrode material, a micropore ratio of 10% or more may be ensured.

In addition, the three-dimensional porous carbon composite may promote the adsorption of negative ions (ClO⁴⁻) by micropores of the positive electrode material.

At this time, the combination of the small positive electrode particles and the 3D graphitized carbon structure is desirable for excellent electrical conductivity and prevents particle aggregation during charge/discharge cycles. At this time, metal-organic frameworks (MOFs) are promising 3D carbon matrices.

In addition, incorporating chemically modified graphene sheets may lead to more innovations. Grafting with 2D graphene sheets may eliminate undesirable MOF crystal aggregation with the outer surface, allowing reversible and fast Na+ insertion/de-insertion functionality and effective electron conduction to the active site through tunable pores.

In addition, the oxygen-containing functional groups on the surface of chemically modified graphene oxide (GO) contribute to the formation of ultrafine positive electrode particles that may allow high capacity and fast faradaic reaction.

On the other hand, the capacity imbalance between battery-type positive electrode and capacitor-type negative electrode is still a bottleneck. Porous carbon structures including commercial activated carbon have been commonly used as capacitor-type negative electrode substances, but they are known to have limited capacity and slow faradaic reaction rate due to limited active sites and slow ion accessibility, which limits the realization of high energy density and fast rechargeable power density.

Therefore, high-capacity/high-rate negative electrode substances are important for realizing high-performance hybrid energy storage. Micropores and mesopores should also be included in the negative electrode substance.

Micropores may provide abundant ion adsorption or storage sites for high capacity, while mesopores may provide diffusion channels for fast ion transport.

On the other hand, the electrical performance may be hampered by high ion diffusion resistance due to the large number of isolated and inaccessible micropores and the lack of mesoporous channels essential for fast ion transport. In addition, graphitic carbon allows organized sp² carbon, contributing to excellent electrical conductivity.

Therefore, a 3D porous conductive carbon framework with a rich pore network that facilitates ion transport and a high degree of graphitization that promotes electron transfer should be constructed to allow high-rate performance in positive electrodes. Zeolic imidazolate frameworks (ZIFs) composed of Zn metal ions and imidazole ligands are promising substances for inducing microporous ion adsorption sites and mesoporous ion transport channels, which are essential for the development of high-capacity/high-rate positive electrode substances.

In addition, the metal ions and functionalized ligands of the secondary building units (SBUs) may be utilized for catalytic graphitization and heteroatom doping. In this study, an S-doped carbon/graphene (FS/C/G) anode with low-crystalline multivalent iron sulfides and a ZIF-derived porous carbon (ZDPC) cathode with 3D porous N-rich graphitic carbon framework are developed to realize high energy density and fast rechargeable SIHES.

The MIL-100(Fe)/GO heterostructure is initially used to synthesize the FS/C/G anode substance. The iron-based MOF, MIL-100(Fe) is composed of benzene-1,3,5-tricarboxylate (BTC) ligands and iron trioctahedral clusters. The uniform and homogeneous growth of MIL-100(Fe) on the GO surface is achieved by coordinating the OH terminal groups of the BTC ligands and iron clusters.

Subsequently, ultrafine iron sulfides are formed inside the 3D porous S-doped N-rich graphitic carbon framework by pyrolysis-assisted graphitic carbon production and negative ion exchange-assisted sulfidation in MIL-100(Fe)/GO. Environmentally non-toxic and inexpensive iron-based sulfides are promising anode substances, but they have the disadvantages of low electrical conductivity, large volume change during charge/discharge cycling, and slow kinetics.

On the other hand, the circulated iron sulfide is shown to rearrange into low-crystalline iron sulfide fragments containing Fe vacancies and multivalent Fe²⁺/Fe³⁺ states. It is noteworthy that the multivalent Fe states increase the electron density in the conduction band, allowing the iron sulfide fragments to function as conducting anode units.

In addition, the size reduction into fragments is proven to be high-capacity, and the interface between the low-crystalline fragments providing multiple ion transport paths and the small iron sulfide fragments reducing the diffusion length is found to allow high-rate performance in FS/C/G anodes.

In addition, the 3D S-doped N-rich graphitic carbon framework contributes to alleviate stress/strain during charge/discharge, ensuring the cycling stability. Furthermore, 3D porous O-doped N-rich carbon structures were synthesized as positive electrode substances on zeolite imidazolate frameworks (ZIFs) via pyrolysis-assisted micropore formation and KOH-assisted mesopore formation, which were revealed by high capacity, O/N-induced defects and mesopores for fast ion transport, O-induced micropores for N-rich graphitic carbon networks for facile electron conduction, and N-functional sites.

In addition, the kinetically well-fitted SIHES cell is assembled in an asymmetric configuration to achieve high energy density by taking advantage of the battery type FS/C/G anode and capacitor type ZDPC cathode electrode.

Long-term stability is also proven by showing that the columbic efficiency remains constant over a long cycle life. In addition, a fast charging kit consisting of several coin type FS/C/G//ZDPC cells connected in series can be used as a power module to demonstrate the fast charging function of the SIHES apparatus.

Hereinafter, the disclosure will be described in more detail through production examples and experimental examples. These production examples and experimental examples are only for illustrative purposes of the disclosure, and the scope of the disclosure is not limited by these production examples and experimental examples.

### Production Example 1: Three-dimensional Porous Carbon Composite Negative Electrode Material Production

### 1) Synthesis of Graphene Oxide (GO) Solution

2 g of graphite powder and 40 mL of concentrated sulfuric acid (H₂SO₄) were mixed and pretreated by sonication for 4 h.

Then, the graphite powder was washed with deionized water and dried overnight at 60° C. in a vacuum oven for further use.

The dried powder was added to 200 mL of concentrated H₂SO₄ (95%) and 36 mL of phosphoric acid (H₃PO₄, 85%). 12 g of potassium permanganate (KMnO4) was slowly added to the mixture while stirring and the temperature was maintained below 100° C.

After mixing, the mixture was stirred for 24 h and the acidity was diluted by carefully adding deionized water. The mixture was placed in an ice bath and the temperature was maintained below 50° C. The mixture was stirred for an additional 24 h.

Then, 30 mL of hydrogen peroxide (H₂O₂, 37%) was added to the reaction mixture and stirred for 24 h. Upon addition of hydrogen peroxide, the color of the mixture changed from dark brown to light yellow with bubbles. The mixture was washed twice with 0.1 M hydrochloric acid (HCl) aqueous solution to remove metal ions.

After that, the mixture was washed three times with deionized water to remove any remaining acid traces.

Then, the mixture was sonicated for 4 h to separate the particles and centrifuged to remove heavy particles.

The concentration of the mixture was adjusted to 4 mg mL⁻¹ and stored under ambient conditions.

### 2) Synthesis of MIL-100(Fe) and MIL-100(Fe)/GO

MIL-100(Fe) was synthesized with slight modifications according to previous reports.

According to the general synthetic method, 5 mmol of iron nitrate nonahydrate (Fe(NO₃)₃·9H₂O), 4.5 mmol of benzene-1,3,5-tricarboxylic acid, and 3 mL of deionized water were poured into a round-bottom flask equipped with a reflux condenser.

At this time, the mixture was stirred and heated at 95° C. for 12 h. The resulting product was washed with hot water and ethanol to remove unreacted chemical matters. The obtained orange powder was dried overnight at 80° C. in a vacuum oven.

MIL-100(Fe)/GO was produced according to the previously mentioned procedure, except that the graphene oxide aqueous solution was dispersed in the mixed solvent.

### 3) FS/C/G-20 Negative Electrode Material Synthesis

The produced MIL-100(Fe) and MIL-100(Fe)/GO were transferred to an alumina crucible and annealed at 700° C. for 2 h in an Ar atmosphere at a linear heating rate of 5° C. min⁻¹.

The resulting samples were denoted as F/C and FC/C/Gx, respectively, where x represents the weight percentage of GO added to the solution during synthesis.

Thiourea (150 mg), FC/C/G-20 (40 mg), and ethanol (15 mL) were mixed and stirred for 30 min.

The mixed solution was then transferred to a 25 mL Teflon-lined stainless steel autoclave.

The mixture was sealed and heated at 180° C. for 2 h.

The black powder was recovered by washing several times with deionized water and ethanol.

The obtained powder was dried in a vacuum oven at 60° C. for 12 h.

After drying, the dried sample was annealed at 550° C. for 3 h in an Ar atmosphere, resulting in the formation of a 3D mesoporous S-doped N-rich graphitic carbon matrix with iron sulfide-confined carbon/graphene (FS/C/G) structure.

A larger active matter size sample (FS/C/G-20, 15.3 nm) was synthesized by increasing the solvothermal process time to 10 h, and the rest of the synthesis procedure was the same.

### Production Example 2: Three-dimensional Porous Carbon Composite Positive Electrode Material Production

ZIF-8 was synthesized with some modifications according to the previously reported work.

The produced ZIF-8 powder was heat-treated at 800° C. for 1 h in an inert atmosphere.

After heat-treatment, the residual Zn was removed by adding concentrated HCl solution.

The product was washed with deionized water to reach a neutral pH level.

Then, this ZIF-derived carbon (ZDC) was dried in a vacuum oven at 60° C. for 12 h for further use.

After drying, with the help of deionized water, the powder was mixed with KOH (mass ratio sample: KOH=1:2).

Then, the mixture was dried at 100° C. and the water was evaporated with slow stirring. The dried sample was collected and transferred to an alumina crucible and heat-treated in a tubular furnace at 800° C. for 1 h at a linear heating rate of 5° C./min in an inert atmosphere.

Then, 10% HCl aqueous solution was added to remove the unreacted KOH.

Finally, the ZIF-8 derived porous carbon (ZDPC) powder was washed several times with deionized water and dried at 60° C. for 12 h under vacuum.

### Experimental Example 1: Three-dimensional Porous Carbon Composite Negative Electrode Material Production and Performance Verification Experiment

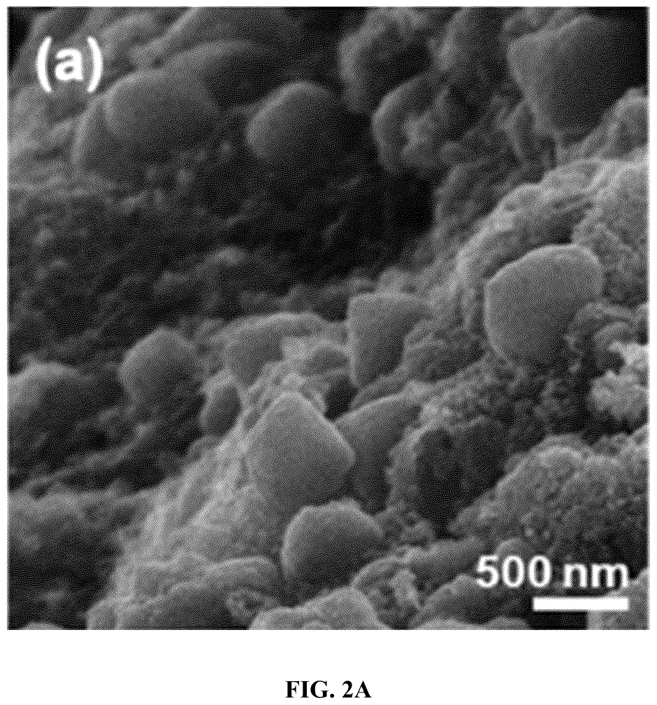

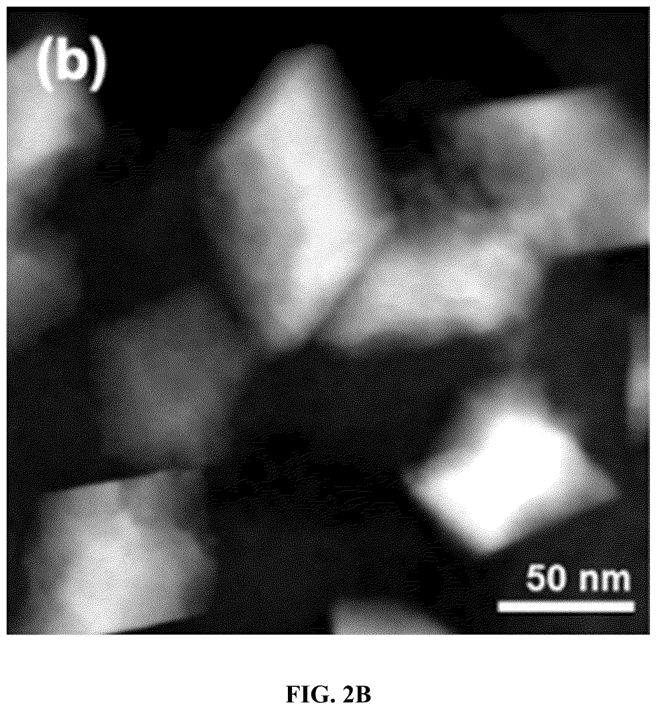

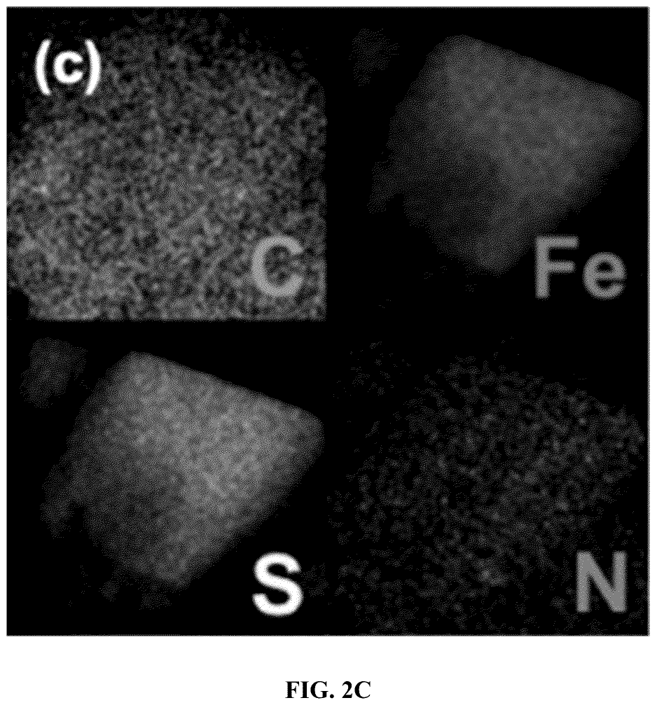

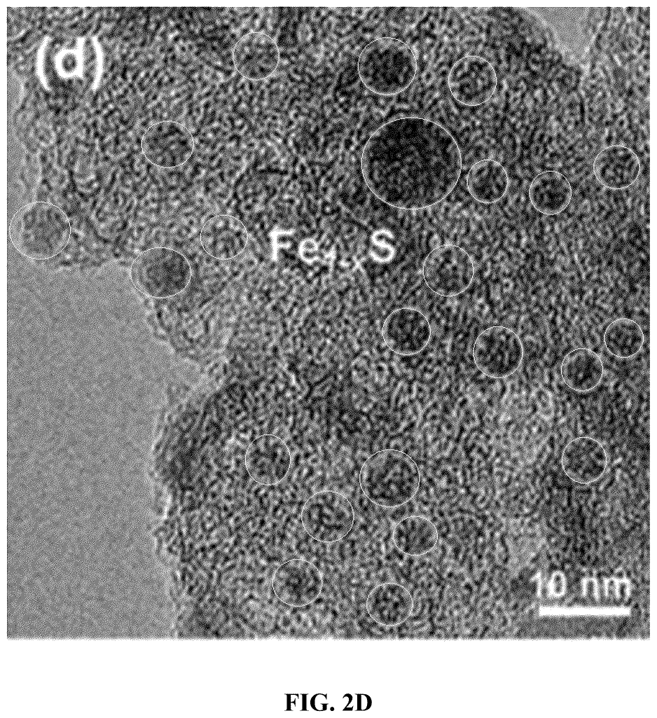

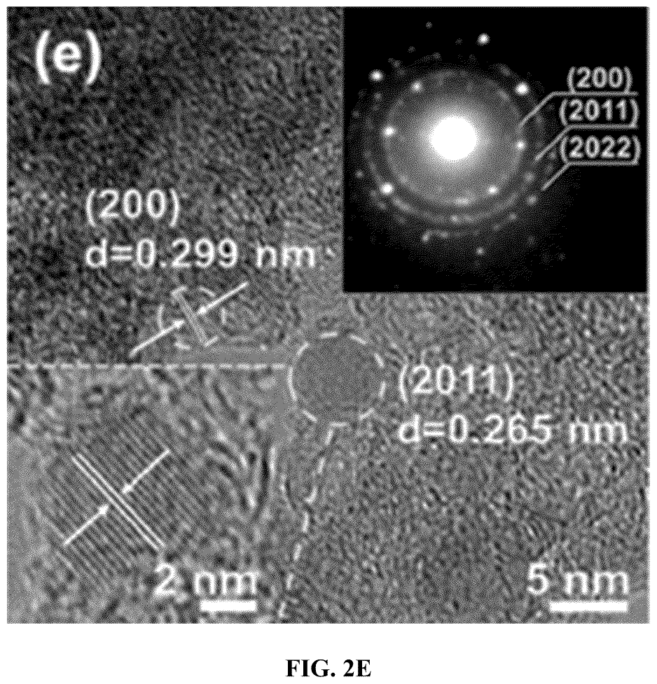

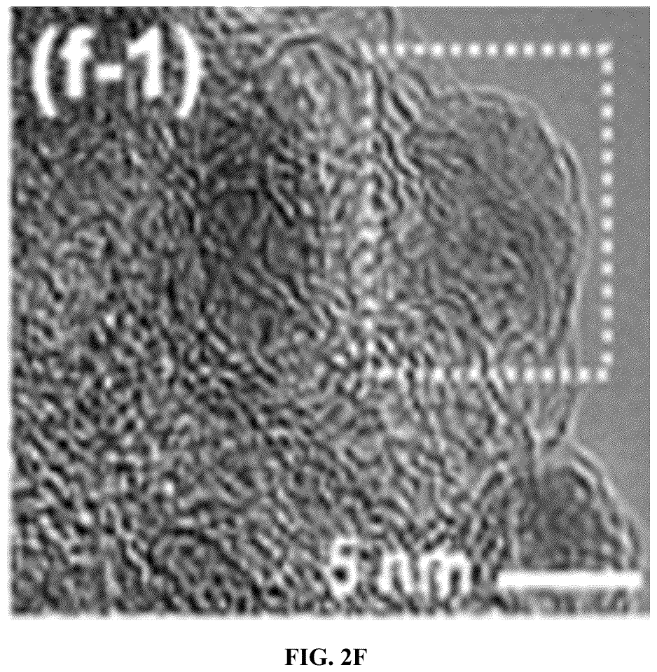

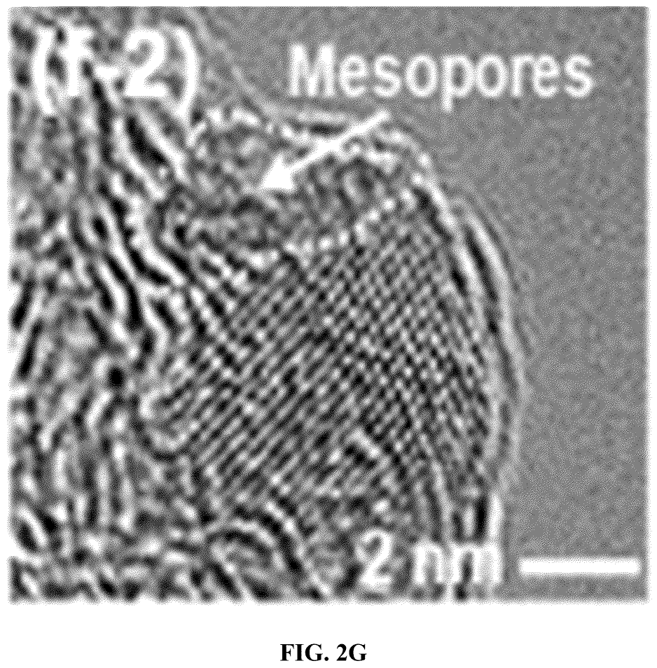

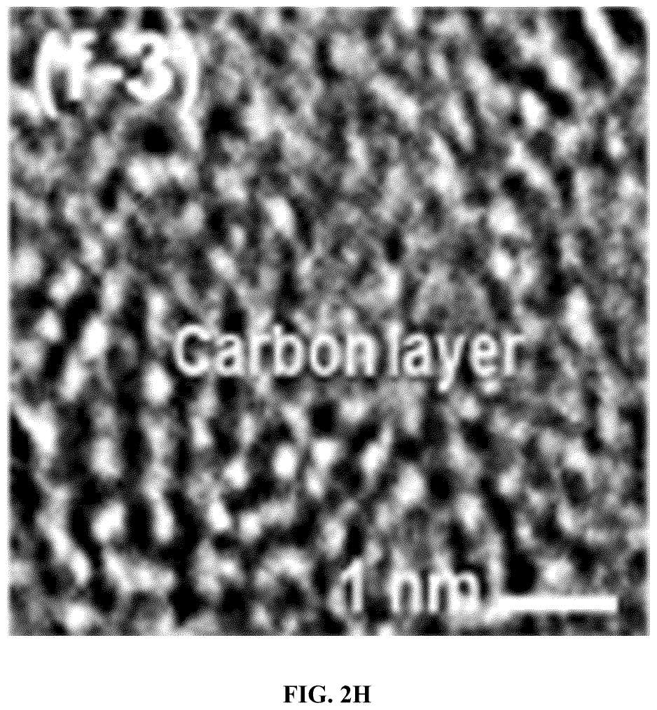

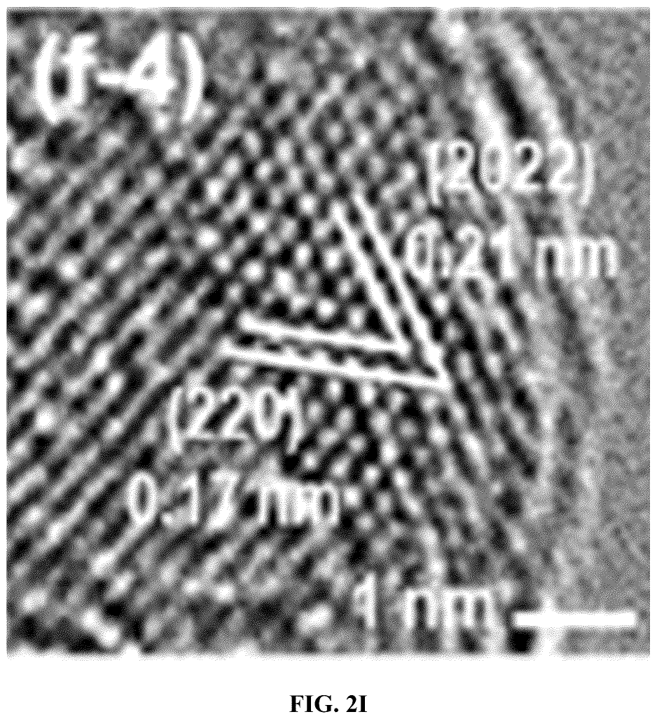

FIGS. 2A, 2B, 2C, 2D, 2E, 2F, 2G, 2H, and 2I are each an optical image showing the structural characteristics of a three-dimensional porous carbon composite negative electrode material of the disclosure.

FIGS. 2A and 2B show the characteristic morphology of MOF on graphene sheets maintained after sulfidation.

The elemental compositions of various negative electrode material matters by energy-dispersive X-ray spectroscopy (EDS) analysis are shown in FIG. 2C.

At this time, uniform distributions of Fe, C, and O were observed for F/C, FC/C/G-20, and FS/C/G-20.

In the case of FS/C/G-20, the uniformly distributed N and S elements indicate that heteroatoms were introduced via the thiourea precursor.

In addition, the HRTEM image of FS/C/G-20 can show ultrafine iron sulfide nanoparticles uniformly doped on the carbon framework derived from MOF, as shown in FIGS. 2D to 2F.

Furthermore, clear XRD patterns corresponding to the (2011) plane with a lattice spacing of 0.265 nm and the (200) plane with a lattice spacing of 0.299 nm were observed.

In addition, the selected area diffraction (SAED) pattern (inset FIG. 2E) shows three distinct diffraction rings corresponding to the (2011), (2022), and (200) planes, and the clear ring patterns indicate the polycrystalline nature of the iron sulfide phase.

In addition, the HAADF-STEM image confirms the presence of well-dispersed iron sulfide with an average size of 3.7 nm within the mesopores. In addition, it is noteworthy that the micropore diameters determined from the N₂ and CO₂ adsorption-desorption isotherms are consistent.

In addition, since the particle size greatly affects the diffusion time, iron sulfide nanoparticles with a size of several nanometers would be beneficial for improving the rate capacity.

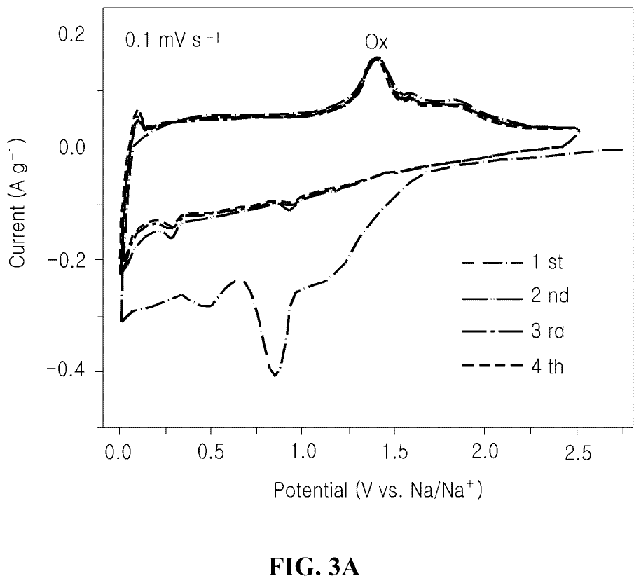

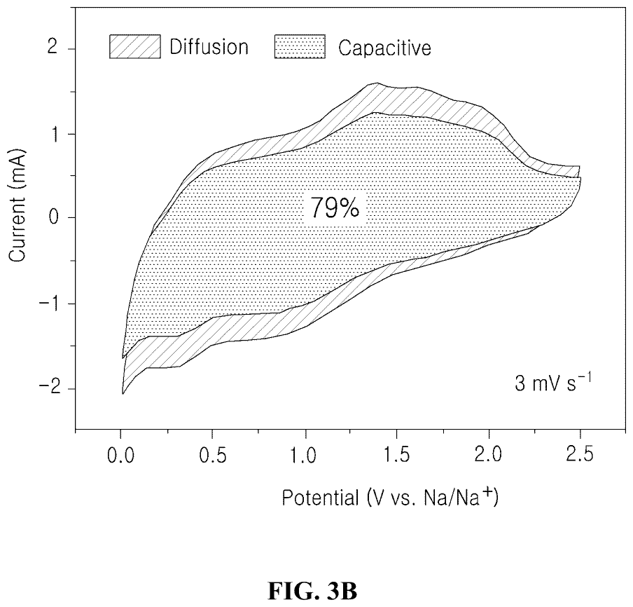

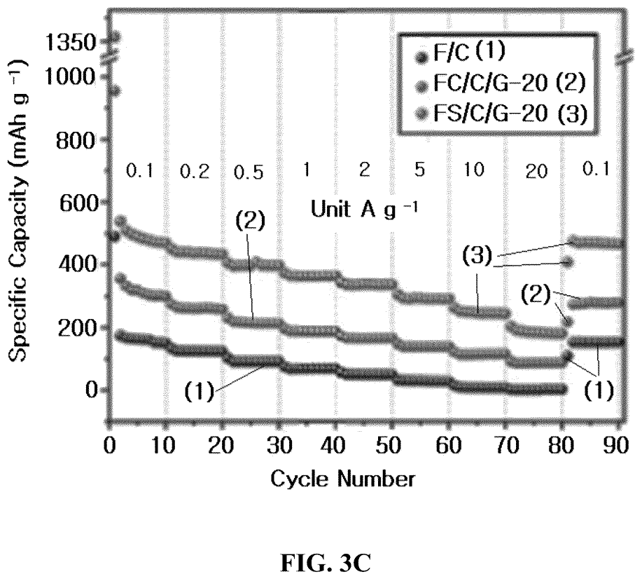

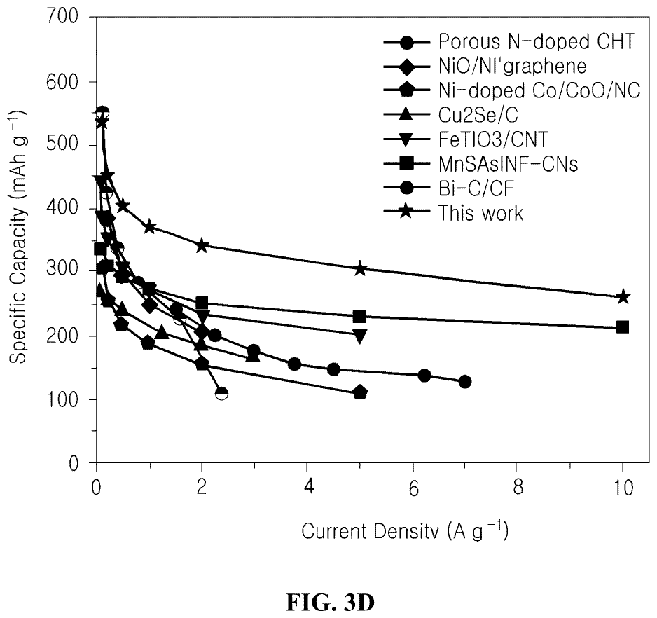

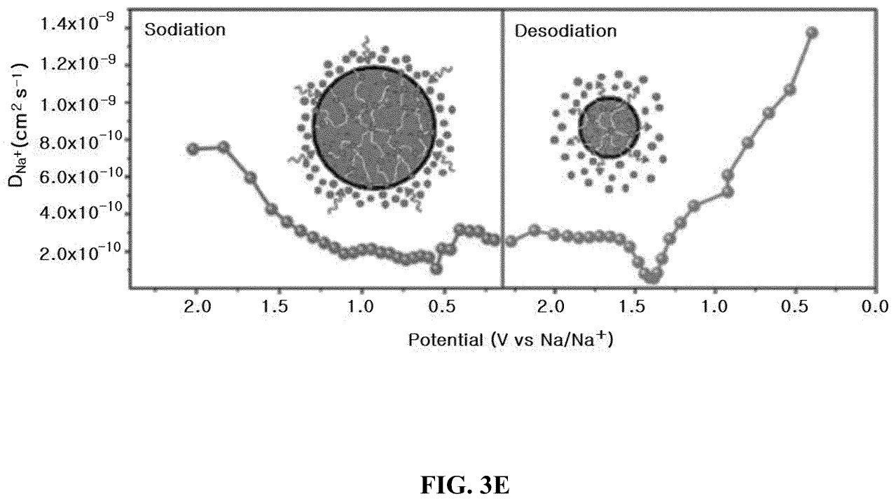

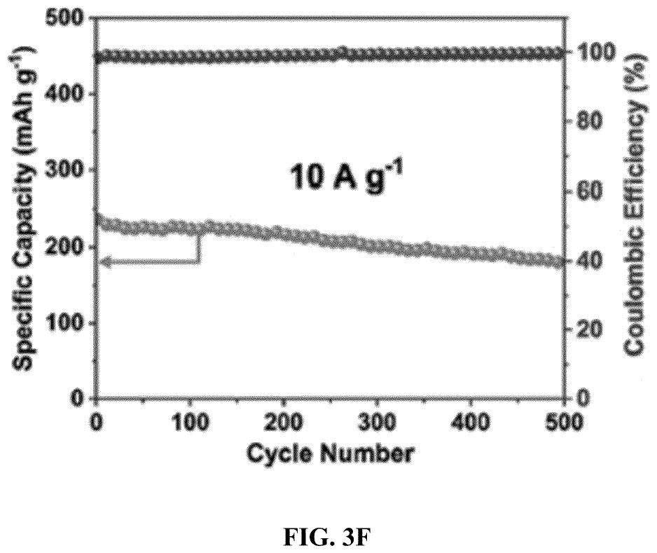

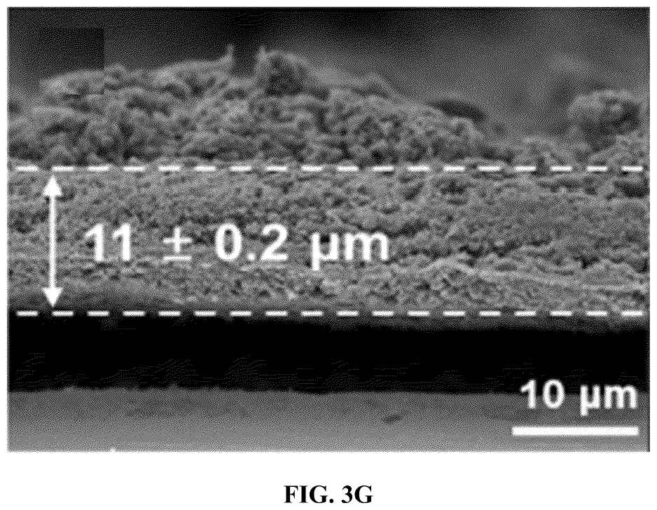

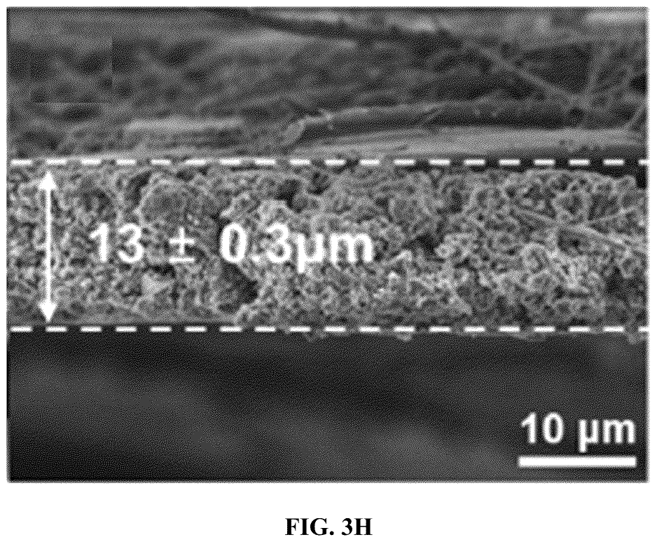

FIGS. 3A, 3B, 3C, 3D, 3E, 3F, 3G, and 3H are each a graph showing the electrochemical performance and characterization of a three-dimensional porous carbon composite negative electrode material of the disclosure.

The electrochemical performance of the anode substance measured in the half-cell configuration is shown in FIGS. 3A, 3B, 3C, 3D, 3E, 3F, 3G, and 3H.

Cyclic voltammetry (CV) analysis was performed between 0.01 and 2.5 V (vs Na/Na⁺) at a scan rate of 0.1 mV s−1.

The CV curves over repeated cycles almost overlap with the second curve, indicating excellent reversibility (FIG. 3A).

In addition, they show that the SEI layer formation occurs during the initial cycling on the FS/C/G-20 surface.

In general, the conversion reaction electrodes experience low electrochemical activity.

However, the results show that FS/C/G-20 allows high electrochemical activity due to the small size of the anode particles.

The percentage of pseudocapacitive contribution gradually increased with increasing scan rate, reaching 79% at a scan rate of 3 mVs⁻¹ (FIG. 3B). The FS/C/G-20 electrode showed a clear redox peak in the CV curve, similar to other battery substances, but the small particle size also triggered the pseudocapacitive effect. The ultrafine nanoparticles increased the contact area with the electrolyte and shifted the bulk redox reaction to a surface reaction.

As a result, a fast faradaic reaction that is not limited by solid-phase diffusion was enabled, which led to an improvement in the rate performance of FS/C/G-20.

As shown in FIG. 3C, the FS/C/G-20 electrode exhibited high reversible specific capacities of 539, 451, 405, 373, 343, 305, and 262 mAhg⁻¹ at 0.1, 0.2, 0.5, 1, 2, 5, and 10 Ag⁻¹, respectively.

Even at a high current density of 20 Ag⁻¹, exhibited was a very high capacity of 203 mAhg⁻¹.

In addition, when the current density was lowered again to 0.1 Ag⁻¹, it exhibited a high specific capacity of 475 mAhg⁻¹, suggesting excellent electrochemical reversibility.

FIG. 3D shows the superior rate performance of FS/C/G-20 compared to previously reported MOF-based electrode substances, including TiOxNy/C, Bi—C/CF, FeTiO₃/CNT, Cu₂Se/C, Ni-doped Co/CoO/NC, NiO/Ni/graphene, and porous N-doped CHT.

The diffusion kinetics of FS/C/G-20 were investigated by electrochemical impedance spectroscopy (EIS) analysis and electrical intermittent titration technique (GITT).

In addition, FS/C/G-20 exhibits a characteristic W shape, where the Dna+v_{Na+} value drops sharply in a certain voltage range where the reduction/oxidation reactions occur (FIG. 3E).

This phenomenon can be explained by the deep insertion/deintercalation of sodium ions and the subsequent phase transition. The D_{Na+} was determined to be 1.37×10⁻⁹ cm²s⁻¹ under fully discharged conditions, which is the highest among the three samples.

As a result, high electrical conductivity, good wettability, and fast sodium ion diffusion kinetics can synergistically affect the rate performance.

Furthermore, long-term stability tests were performed to investigate the structural robustness. FIG. 3F shows that FS/C/G-20 provides 237 mAhg⁻¹ at 10 Ag⁻¹ after activation cycles and retains 76.2% of the specific capacity after 500 cycles.

FIGS. 3G to 3H show in situ SEM images before cycling and complete sodiation/de-sodiumization after 300 cycles. Compared to the volume of the fresh electrode, a volume expansion of 282% was observed when the electrode was discharged to 0.01 V.

In addition, the electrode volume recovered to 118% when charged to 2.5 V, demonstrating that the carbon platform successfully accommodates the volume change during repeated cycling. Generally, conversion reaction-based energy storage substances provide high capacity but have low cycling stability due to large volume change.

However, the anode substance with a limited nano-sized iron sulfide particles showed excellent cycle performance, which is attributed to the short diffusion length and reduced stress/strain that facilitate electrochemical reversibility. On the other hand, FS/C/G-20 containing iron sulfide phase with a larger particle size was synthesized to demonstrate the beneficial effect of small active matter size. The larger-sized FS/C/G- 20 sample with an average particle size of 15.3 nm showed inferior electrochemical performance in terms of rate capacity and cycle stability, which implies the longer diffusion length and increased stress/strain of the larger-sized active matter.

In addition, the superiority of the smaller-sized FS/C/G-20 was further confirmed in accordance with previous studies, suggesting its advantage in terms of rate capacity and cycle stability.

Therefore, size engineering of the active matter can be confirmed as one of the most effective strategies to realize high-performance electrode substances. Furthermore, the carbon matrix helps to suppress the capacity fading that commonly occurs in conversion electrodes.

### Experimental Example 2: Three-dimensional Porous Carbon Composite Positive Electrode Material Production and Performance Verification Experiments

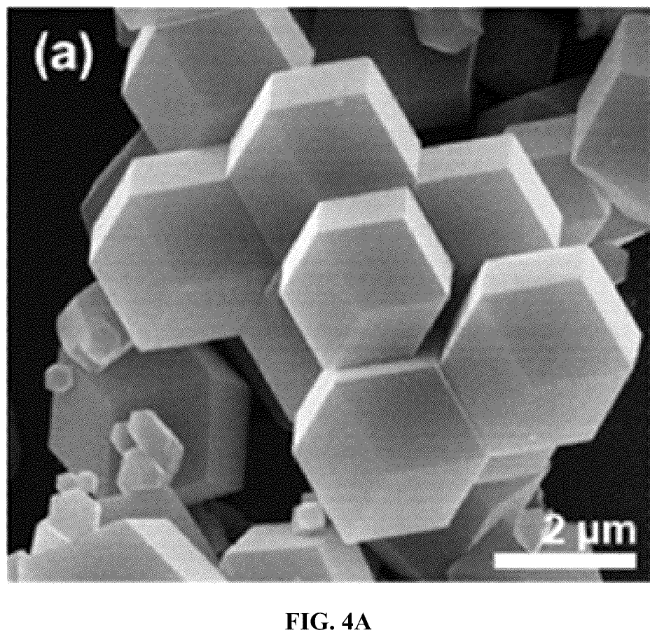

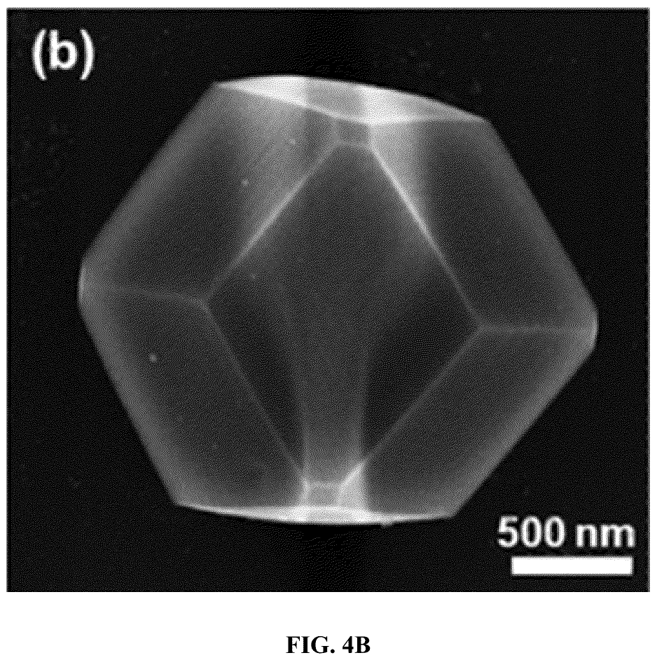

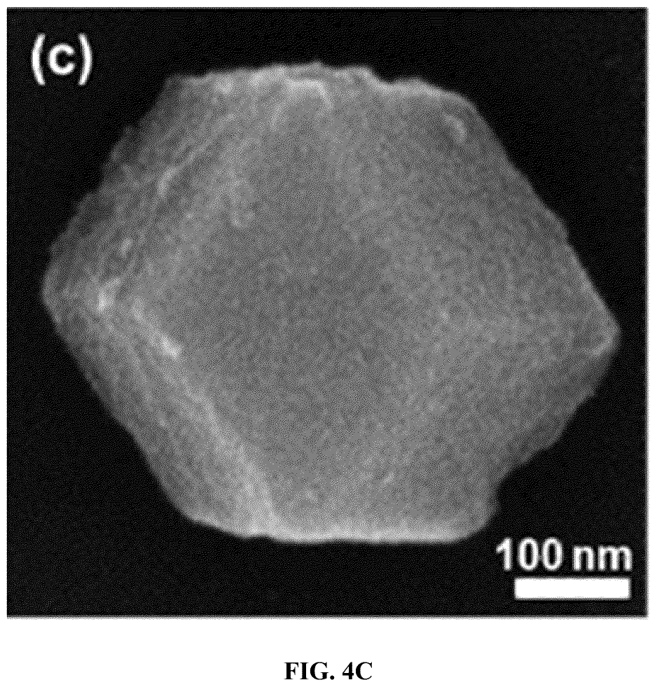

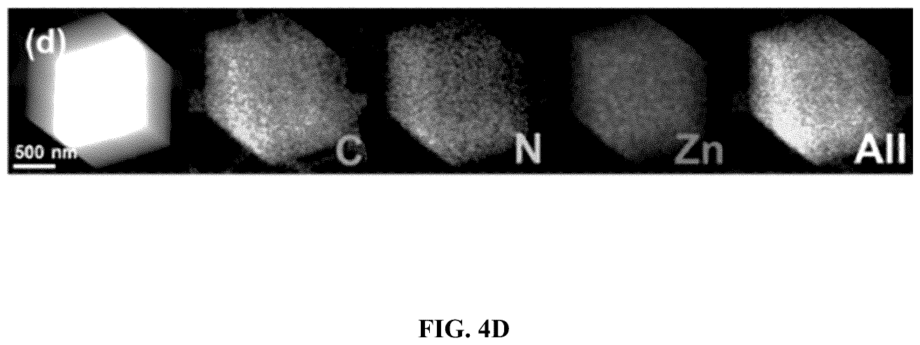

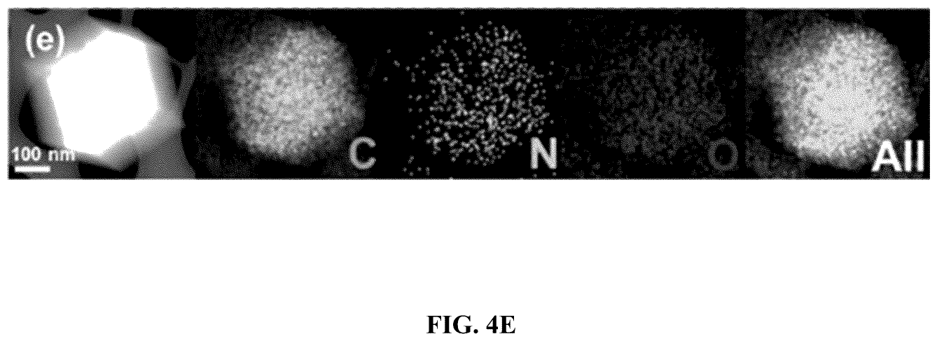

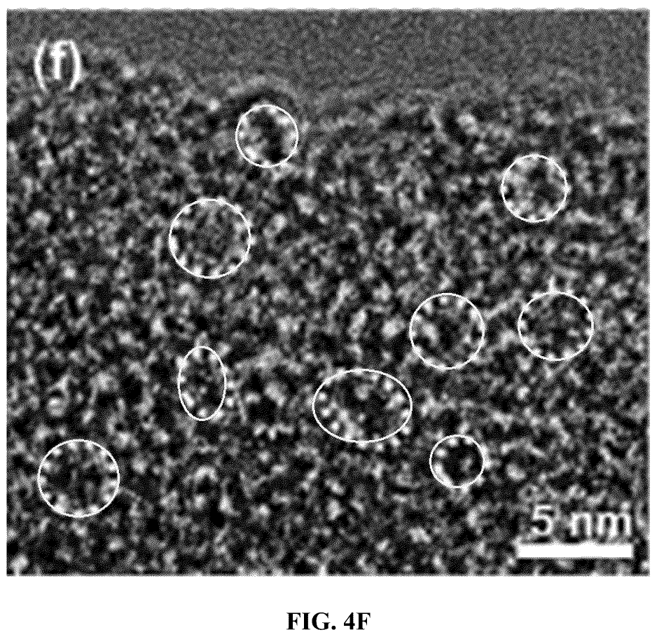

FIGS. 4A, 4B, 4C, 4D, 4E, and 4F are each an optical image showing the structural characteristics of a three-dimensional porous carbon composite positive electrode material of the disclosure.

FIGS. 4A to 4C show the characteristic polyhedral morphology of ZIF-8.

The presence of C, N, and Zn was confirmed by EDS elemental mapping shown in FIG. 4D.

The polyhedral shape of FIG. 4C was maintained after subsequent carbonization and KOH activation processes.

In addition, FIG. 4E additionally shows the heteroatoms distributed uniformly in the carbon matrix.

In addition, FIG. 4F shows abundant mesoporous channels beneficial for ion transport in ZDPC. The absence of distinct peaks in the XRD pattern of ZDPC reveals its amorphous nature.

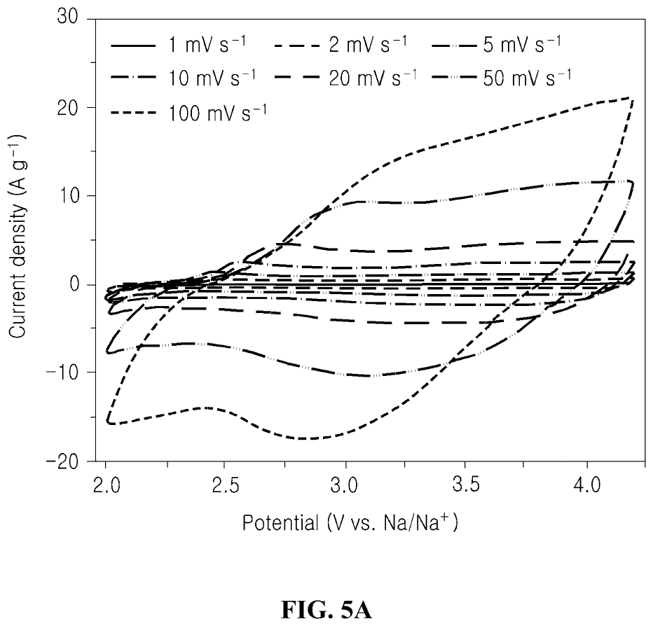

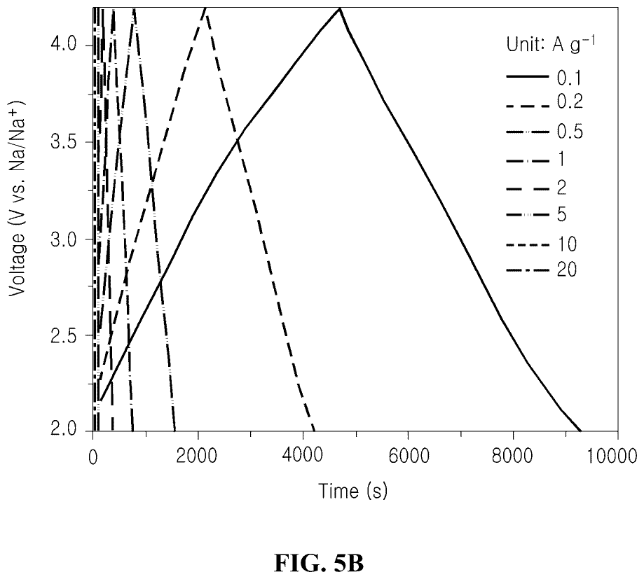

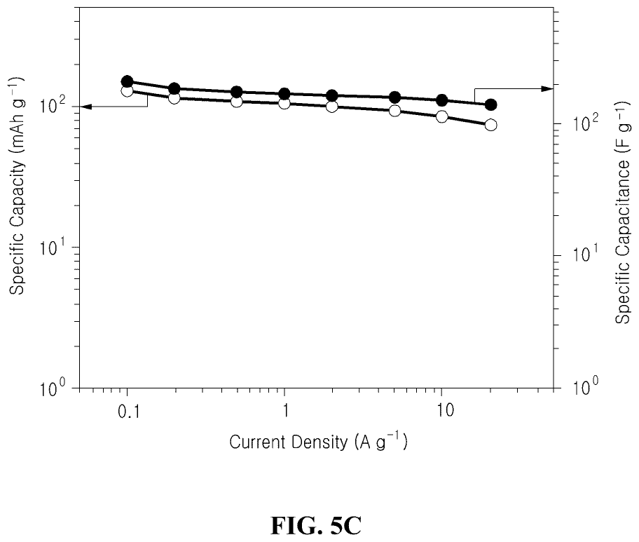

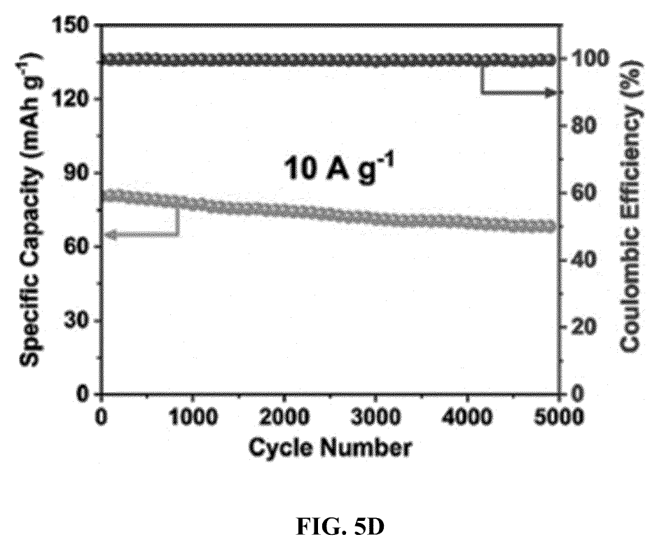

FIGS. 5A, 5B, 5C, and 5D are each a graph showing the electrochemical performance and characterization of a three-dimensional porous carbon composite positive electrode material of the disclosure.

FIG. 5A shows the CV curve of ZDPC, which has a relatively rectangular shape with a slight bump. The GCD curve in FIG. 5B is quasi-linear without a plateau.

The initial four cycles of the GCD and CV curves overlap within three cycles, suggesting excellent electrochemical reversibility.

The ZDPC in FIG. 5C exhibited the highest capacity of 127 mAhg⁻¹ at 0.1 Ag⁻¹ and delivered 74 mAhg⁻¹ even at a very high current density of 20 Ag⁻¹.

This surprisingly high capacity of ZPDC is attributed to the O-doped N-rich graphitic carbon and the pore size suitable for the electrolyte negative ion (ClO⁴⁻).

FIG. 5D shows the long-term cycling stability at a current density of 10 Ag⁻¹.

The ZDPC electrode exhibited strong cycle life with a capacity retention of 85% after 5000 cycles and a capacity loss of 0.003% per cycle, which may ensure electrochemical stability over the tested voltage range.

### Experimental Example 3: Verification Experiment of Hybrid Sodium Ion Capacitor Including Three-dimensional Porous Carbon Composite Negative Electrode Material and Positive Electrode Material

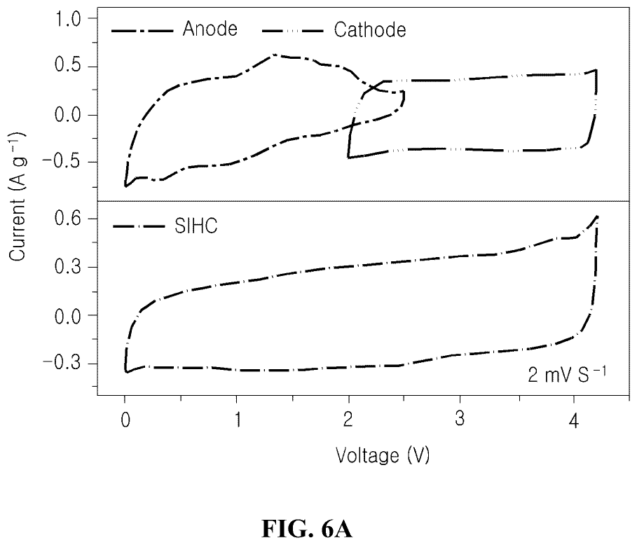

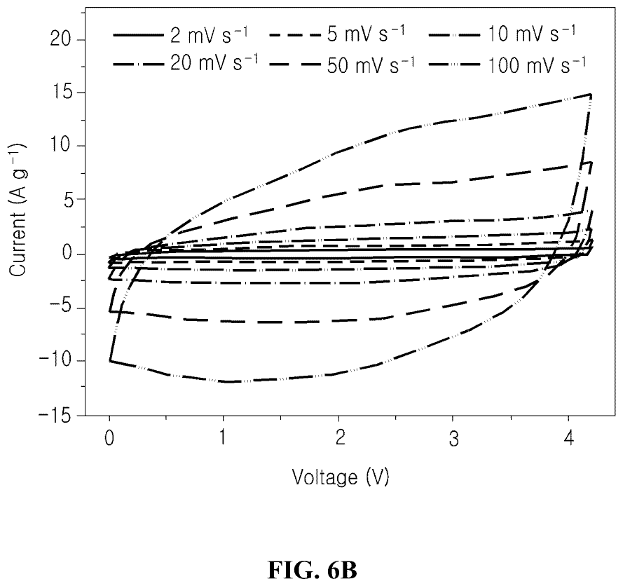

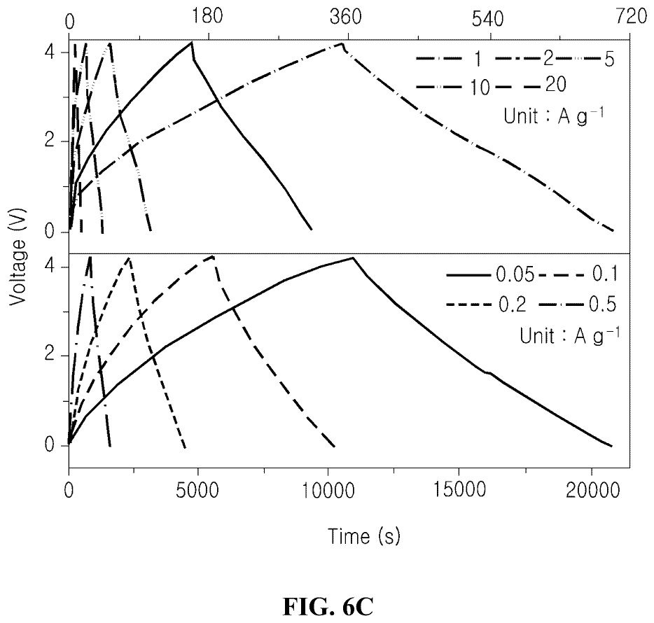

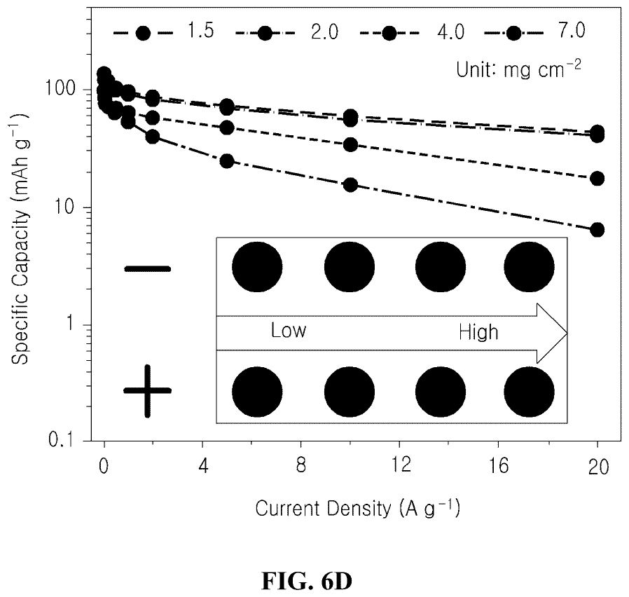

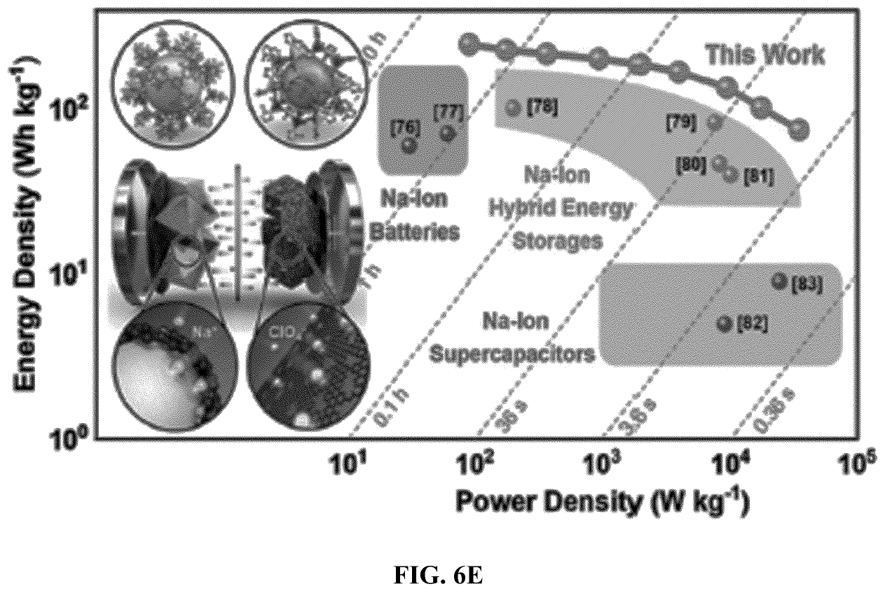

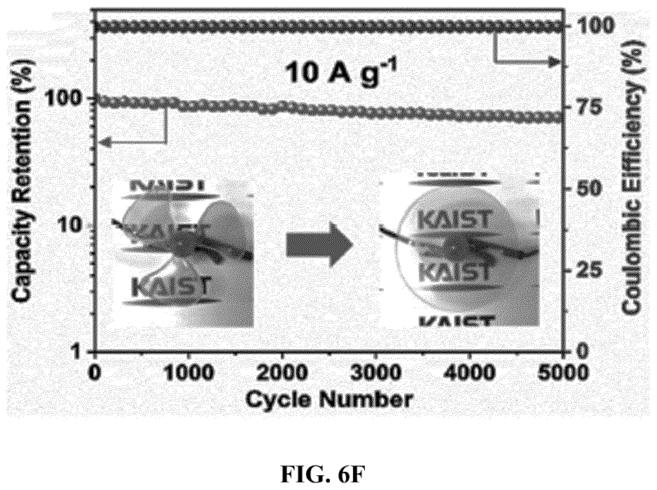

FIGS. 6A, 6B, 6C, 6D, 6E, and 6F are each a graph showing electrochemical characterizations of a hybrid sodium ion capacitor including a three-dimensional porous carbon composite negative electrode material and positive electrode material of the disclosure.

FIG. 6A shows the operating potential ranges of the positive electrode, negative electrode, and complementary hybrid sodium-ion hybrid energy storages (SIHES) batteries.

Based on the aforementioned results, the operating mechanism of the SIHES battery is proposed as follows. During charging, sodium ions are inserted from the FS/C/G-20 electrode and a conversion reaction occurs. At the same time, ClO⁴⁻ negative ions are adsorbed on the ZDPC surface to satisfy charge neutrality. During discharging, the reverse process occurs.

A deconversion reaction occurs, sodium ions are desorbed from the positive electrode, and negative ions are desorbed from the opposite side.

Eventually, both positive and negative ions return to the organic electrolyte.

The electrochemical reaction rates were evaluated by conducting CV curves and GCD tests of the FS/C/G-20//ZDPC SIHES battery.

FIGS. 6B and 6C show quasi-rectangular and quasi-triangular shapes, which are slightly different from the ideal shape due to the mismatch of the two charge storage mechanisms.

In addition, the rate capacity of the FS/C/G-20 SIHES cells with various mass loadings was tested at various current densities from 0.05 A g⁻¹ to 20 Ag⁻¹, as shown in FIG. 6D.

The produced devices achieved relatively high energy and power densities even at high active matter loadings of 7 mg=cm⁻².

It is well known that thicker electrodes lead to longer transport distances and increased tortuosity, which affect the transport rates of electrons and ions.

In addition, the full-cell device exhibited a maximum areal capacity of 0.6 mAhcm⁻², further confirming the potential of the FS/C/G-20//ZDPC SIHES full-cell as a promising electrochemical energy storage device.

In addition, FIG. 6E shows the Ragone plots for FS/C/G-20//ZDPC and other state-of-the-art electrochemical full-cells such as aqueous/non-aqueous SIB, SIHES, and supercapacitors.

When the high-capacity/high-rate FS/C/G-20 anode was combined with the high-capacity/high-rate ZDPC cathode, the full-cell configuration of FS/C/G-20//ZDPC SIHES achieved the highest energy density to date while maintaining fast rechargeable power density.

Furthermore, the long-term cycling stability of FS/C/G-20//ZDPC was investigated at a very high current density of 10 Ag⁻¹.

FIG. 6F supports that FS/C/G-20//ZDPC provides excellent capacity retention with a Coulombic efficiency close to 100% over 5000 cycles.

In addition, a charging module consisting of three FS/C/G-20//ZDPC full cells in series was used as a power source for a fan and a light-emitting diode (LED).

Referring to FIG. 6F, the mini fan and LED operated only in the on state. The power module was recharged within 30 seconds, which may demonstrate the fast recharge power characteristics of the SIHES battery.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

What is claimed is:

1. A three-dimensional porous carbon composite having a three-dimensional porous carbon framework derived from a metal-organic framework (MOF), the three-dimensional porous carbon composite comprising:
a graphitized carbon structure produced through a heat treatment and subsequent treatment process of the metal-organic framework (MOF), and having a three-dimensional network structure; and
heterogeneous elements dispersed and doped inside the graphitized carbon structure, and composed of nitrogen (N), sulfur (S), or oxygen (O),
wherein the three-dimensional porous carbon composite is used as a material for a negative electrode or a positive electrode of a hybrid sodium ion capacitor.

2. The three-dimensional porous carbon composite of claim 1, wherein in the graphitized carbon structure, when used as the negative electrode of the hybrid sodium ion capacitor, the metal-organic framework (MOF) includes MIL-100(Fe) and graphene oxide, and when used as the positive electrode of the hybrid sodium ion capacitor, the metal-organic framework (MOF) includes ZIF-8.

3. The three-dimensional porous carbon composite of claim 1, wherein in the graphitized carbon structure, with respect to the subsequent treatment process, when used as the negative electrode of the hybrid sodium ion capacitor, a metal-organic framework (MOF) support is converted through a sulfidation process, and when used as the positive electrode of the hybrid sodium ion capacitor, the metal-organic framework (MOF) support is converted through a KOH activation process.

4. The three-dimensional porous carbon composite of claim 1, wherein when the three-dimensional porous carbon composite is used as the material for the negative electrode, low-crystallinity multivalent iron sulfide (Fe²⁺ or Fe³⁺) is inserted into the graphitized carbon structure, and a sulfur (S)-doped and nitrogen (N)-doped structure is formed.

5. The three-dimensional porous carbon composite of claim 4, wherein the low-crystallinity multivalent iron sulfide is in a range of 70 wt. % to 71 wt. % of a total negative electrode material.

6. The three-dimensional porous carbon composite of claim 4, wherein the low-crystallinity multivalent iron sulfide has an average particle size of 3 nm to 5 nm.

7. The three-dimensional porous carbon composite of claim 4, wherein the nitrogen (N) is doped in an amount of 2 to 3 atomic % of a total negative electrode material.

8. The three-dimensional porous carbon composite of claim 1, wherein when the three-dimensional porous carbon composite is used as the material for the positive electrode, a structure in which the oxygen (O) and the nitrogen (N) are doped in the graphitized carbon structure is formed.

9. The three-dimensional porous carbon composite of claim 7, wherein the oxygen (O) is doped in an amount of 6 to 7 atomic % of a total positive electrode material, and the nitrogen (N) is doped in an amount of 2 to 3 atomic % of the total positive electrode material.

10. The three-dimensional porous carbon composite of claim 7, wherein when the three-dimensional porous carbon composite is used as a positive electrode material, a micropore ratio of at least 10% is ensured.

11. The three-dimensional porous carbon composite of claim 10, wherein the three-dimensional porous carbon composite promotes an adsorption of negative ions (ClO⁴⁻) by micropores of the positive electrode material.
